(19) United States
(12) Patent Application Publication
(10) Pub. No.: US 2011/0283904 A1
(43) Pub. Date: Nov. 24, 2011

(54) TWO-DIMENSIONAL SCREEN MATERIAL AND SCREEN

(75) Inventors: Heinz Brocker, Herisau (CH); Hans-Rudolf Frick, Thal (CH); Rolf Forrer, Thal (CH); Roland Greutmann, Speicherschwende (CH)

(73) Assignee: GALLUS FERD. RUEESCH AG, St. Gallen (CH)

(21) Appl. No.: 13/110,176

(22) Filed: May 18, 2011

(30) Foreign Application Priority Data
May 19, 2010 (DE) 10 2010 021 062.5

(51) Int. Cl. B05C 17/06

(52) U.S. Cl. 101/127

(57) ABSTRACT

A screen is formed from a two-dimensional screen material and used in rotary screen printing. The screen material is formed from webs, for instance threads, forming a screen structure and arranged at an angle relative to each other and forming the screen structure with longitudinal openings such as longitudinal meshes.

### CROSS-REFERENCE TO RELATED APPLICATION

This application claims the priority, under 35 U.S.C. §119, of German application DE 10 2010 021 062.5, filed May 19, 2010; the prior application is herewith incorporated by reference in its entirety.

### BACKGROUND OF THE INVENTION

### Field of the Invention

The present invention relates to a two-dimensional screen material for use in screen printing, in particular in rotary screen printing. The screen material includes webs forming a screen structure and arranged at an angle relative to each other and forming the screen structure with longitudinal openings. The invention further relates to a screen formed form the two-dimensional screen material.

Screens and fabrics are known to be used in different industries. In the field of filtration, the square mesh shape is most common. The mesh shape has been adopted by the printing industry. Due to the available photolayers and the known methods of application, an acceptable image resolution can only be achieved with a large number of “supports”. For this reason, fabrics having a high mesh count have become increasingly common.

In the field of printed electronics, the screens—or rather the screen fabric—need to be as thin as possible, i.e. the wires they consist of must be very thin to ensure a high flow rate of the pastes and to be able to print very delicate images.

The coating of solar cells requires a high degree of precision, a fine image resolution, and the application of a high amount of paste, for example when conductive paths are to be applied in a way to cover as few solar cells as possible to ensure a high degree of efficiency of the solar cell.

The screens and fabric types used for printing electronic structures are very expensive and very delicate to process. Thus they are unsuited for the production of screen printing plates for rotary screen printing, even more so because the screen fabrics for a rotary screen can be tensioned only in one direction, i.e. along the longitudinal axis of the cylinder, whereas in flatbed screen printing, they can be tensioned in two dimensions.

In rotary screen printing, the ink is transported through the screen due to the hydrodynamic pressure that is created in front of the front face of the doctor blade by the rotation of the screen when the doctor blade is engaged. For constructional reasons, only open or semi-open doctor blade systems can be used. This means that the dynamic pressure is influenced by a number of aspects such as viscosity, ink content, and rotary speed. Increasing the rotary speed or the ink content are simple ways to increase the hydrodynamic pressure.

A rotary screen printing unit of this kind is described, for instance, in international patent disclosure WO 99/19146A1, corresponding to U.S. Pat. No. 6,412,407.

In the prior art, high-grade steel fabrics with plain weave are used as basic structures for screen materials. The ratio of screen opening, contact surface, and fabric thickness has proved to be suitable. The thickness of the structure, i.e. the fabric thickness (original measure before calendering) approximately corresponds to twice the wire thickness. In a further step, the basic structure is processed in a calendering process and thus brought to the desired raw fabric thickness. This is also a way to increase the smoothness of the screen and thus to reduce the amount of wear on the screen and the doctor blade. In the subsequent nickel-plating process, the fabric is reinforced to make it more wear-resistant and the points of support in the region of the crossings are enlarged.

A method of producing such screen materials is described, for example, in published, non-prosecuted European patent application EP 0 182 195 A2, corresponding to U.S. Pat. No. 4,705,608.

To ensure a high degree of stability of the screen material, a close-mesh structure with many points of support is selected. There are a number of disadvantages inherent in these screen materials and screens known from the prior art.

When images containing large surfaces are to be printed, the printing speed is limited by the spreading properties of the ink. Clouds may form, disruptions in the print may occur, and the surface may be rough, thus making subsequent overprinting, for instance in a flexographic printing operation, more difficult.

In addition, the openings of close-mesh screen materials that have a square mesh shape may become clogged due to what is known as the flake shape of the ink particles. This is detrimental to the quality of the print.

There are limitations to the use of the screen materials common today in rotary screen printing, whether they are steel fabrics or electronically formed grids. As explained above, this is due to the fact that the screen materials had originally been developed for other applications.

### SUMMARY OF THE INVENTION

It is accordingly an object of the invention to provide a two-dimensional screen material and a screen which overcome the above-mentioned disadvantages of the prior art devices of this general type, which are particularly suitable for rotary screen printing.

With the foregoing and other objects in view there is provided, in accordance with the invention a two-dimensional screen material for use in screen printing, including rotary screen printing. The two-dimensional screen material contains webs forming a screen structure and disposed at an angle relative to each other and forming the screen structure with longitudinal openings defined between the webs. The webs are made of metal at least at their surfaces, the metal is deposited on the webs in a galvanizing process. A first width of the longitudinal openings in a direction of longitudinal axes of the longitudinal openings is greater than a second width of the longitudinal openings in a direction of transverse axes of the longitudinal openings.

Furthermore a screen is formed from the above-described two-dimensional screen material.

The screen and screen material of the invention are particularly advantageous because they meet the specific requirements of rotary screen printing and thus ensure a high printing speed and high-quality printing.

In accordance with the invention, a two-dimensional screen material that is suitable for screen printing applications, in particular for rotary screen printing, contains webs that are arranged at an angle relative to each other and form a screen structure. Advantageously, the webs form a structure or pattern, for instance a mesh, of longitudinal openings. The longitudinal shape of the opening enhances the flow of ink.

Advantageously, the surfaces of the webs are made of metal, in particular of nickel, which is particularly advantageous and thus preferred. The metal was deposited on the webs in an electroplating or galvanization process. In addition, the screen material may have a thinned, i.e. smoothened, screen structure created in a calendering process. During the calendering, rollers exert pressure onto the screen structure. Such a calendering process is described, for example, in German Utility Model DE 691 08 040 T2.

In accordance with an advantageous further development of the two-dimensional screen material of the invention, the longitudinal openings are shaped in such a way that their width in the direction of the longitudinal axes of the openings is greater than their width in the direction of the transverse axes of the openings. Compared to conventional screen material of the prior art, this shaping of the openings in accordance with the invention is advantageous because the enlarged screen opening considerably enhances the flow of ink.

Thus in an advantageous embodiment of the invention, the open screen surface A0 of the screen structure ranges between 20% and 40%. In this context, the open screen surface A0 refers to the ratio between the open surface, i.e. the openings, and the total surface of the screen material.

Advantageously, the number of openings per inch of the screen structure in the direction of the longitudinal axes of the structure is between 20 and 400, in particular between 40 and 300, and in the direction of the transverse axes of the structure between 50 and 600, in particular between 60 and 400. If the openings are formed by a mesh structure, the measure is mesh per inch. The unit used for this measure is Mesh, which is calculated as follows:

Mesh count per inch [Mesh]=25.4 mm/p [mm], p referring to the spacing, i.e. the distance between the central axes of two wires in millimeters.

In accordance with a first embodiment, the screen structure of the two-dimensional screen material is of one piece. This is attained in a manufacturing process for creating homogeneous and porous surface structures: single-stage or multi-stage electroforming with additive build-up such as electroplating or galvanizing, or single-stage or multi-stage photomechanical processes with subtractive material removal such as etching, or mechanical processes such as milling, cutting, and/or ablation by laser or water jets, punching, boring, stereolithographic forming or formation by sintering, printing, casting, or foaming. The basic materials used to create the two-dimensional screen structure may be metals, preferably nickel, homogeneous plastics or fiber-reinforced plastics or metal/plastic combinations.

In accordance with a second embodiment, the two-dimensional screen material is formed by a fabric such as a synthetic fabric or metal-wire fabric with webs formed by threads. The structure formed by the threads advantageously assumes the shape of what are known as longitudinal meshes, e.g. rectangular meshes.

The screen structure may be a 1:1 plain weave, also known as tabby weave or taffeta weave. Alternatively, the screen structure may be a twill weave, in particular a 2:1, 3:1 or 4:1 twill weave, which may also be referred to as a 3, 4, or 5 twill weave. The threads that form the longitudinal meshes are referred to as warp threads and weft threads. In a 1.1 plain weave, a warp thread alternately passes over and under the weft threads.

In a 2:1, 3:1, and 4:1 twill weave, one warp thread alternately passes over two, three, and four weft threads, respectively, and then under one weft thread. A particularly advantageous feature is to provide essentially straight weft threads located in the same plane.

Alternative ways of denoting an x:y weave are x/y weave and x-y weave. An additional advantageous feature is to provide warp and weft threads of identical diameters.

In accordance with the invention, a screen for rotary screen printing is made of a two-dimensional screen material as described above and is shaped as a cylindrical sleeve. Advantageously, the greatest width of the openings of the structure formed by the webs is approximately oriented in the direction of the circumference of the screen. This advantageously ensures good ink flow properties of the screen because the ink particles meet with a reduced resistance. Thus even large “flake-shaped” ink particles may pass through the longitudinal openings of the screen structure more easily and clogging of the screen becomes less of a problem. Alternatively or additionally, the longitudinal axes of the structure may be aligned at an acute or obtuse angle relative to the direction of the circumference of the screen. This advantageously ensures that what can be described as the “parallel-edge effect” of a doctor blade used in rotary screen printing can be considerably reduced, thus considerably enhancing print quality for printed images whose edges run parallel with the edge of the doctor blade.

In accordance with an advantageous further development of the screen of the invention one side of the two-dimensional screen material is provided with a polymeric coating, in particular with a photopolymer coating so that imaging in accordance with a process known to those skilled in the art is possible.

The invention described above and the advantageous developments thereof described above likewise form advantageous embodiments of the invention in any combination with each other.

Other features which are considered as characteristic for the invention are set forth in the appended claims.

Although the invention is illustrated and described herein as embodied in a two-dimensional screen material and a screen, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Further advantages and advantageous embodiments of the invention will become apparent from the dependent claims and from the description of an exemplary embodiment with reference to the accompanying drawings.

### BRIEF DESCRIPTION OF THE SEVERAL VIEWS OF THE INVENTION

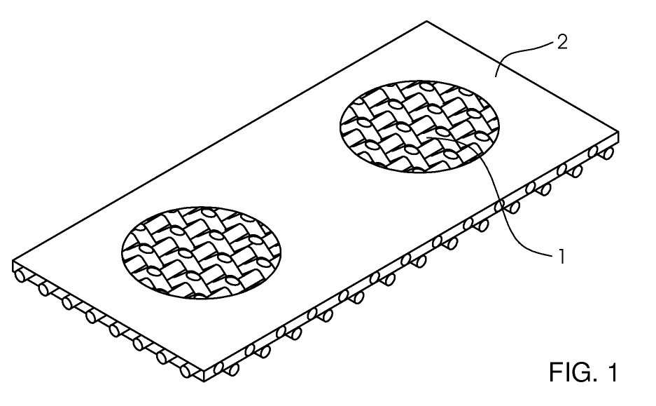

FIG. 1 is a diagrammatic, perspective view of a screen material according to the invention;

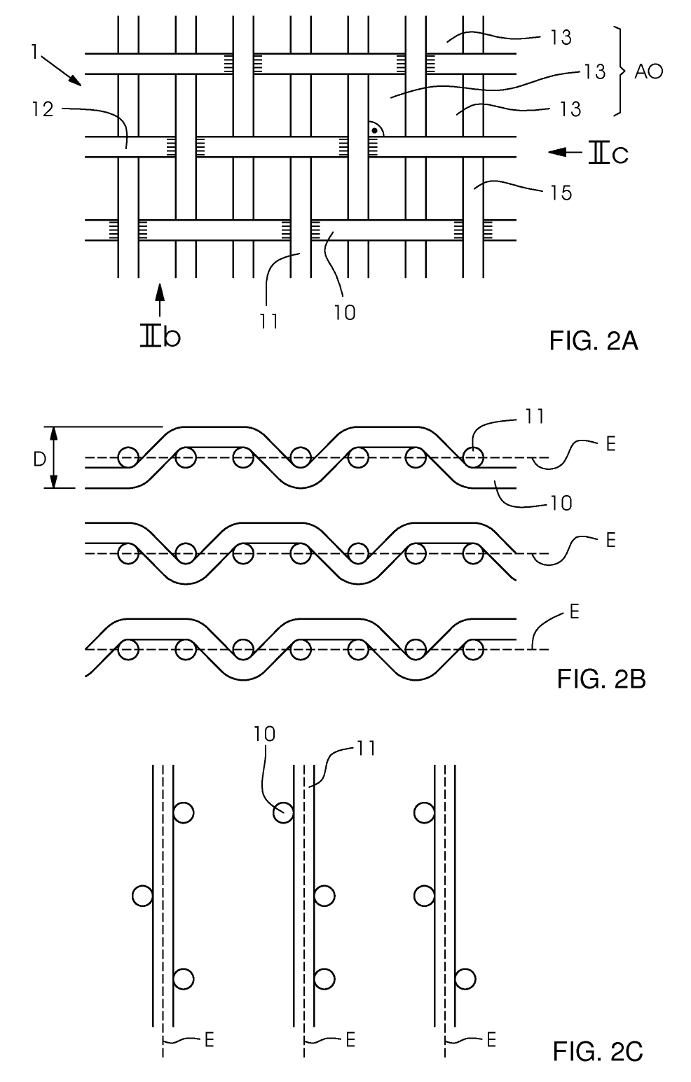

FIG. 2A is a diagrammatic, elevational view of a two-dimensional screen material in a 2:1 twill weave;

FIG. 2B shows diagrammatic, sectional views of the screen material shown in FIG. 2A as viewed through the weft threads;

FIG. 2C shows diagrammatic, sectional views of the screen material shown in FIG. 2A as viewed through the warp threads;

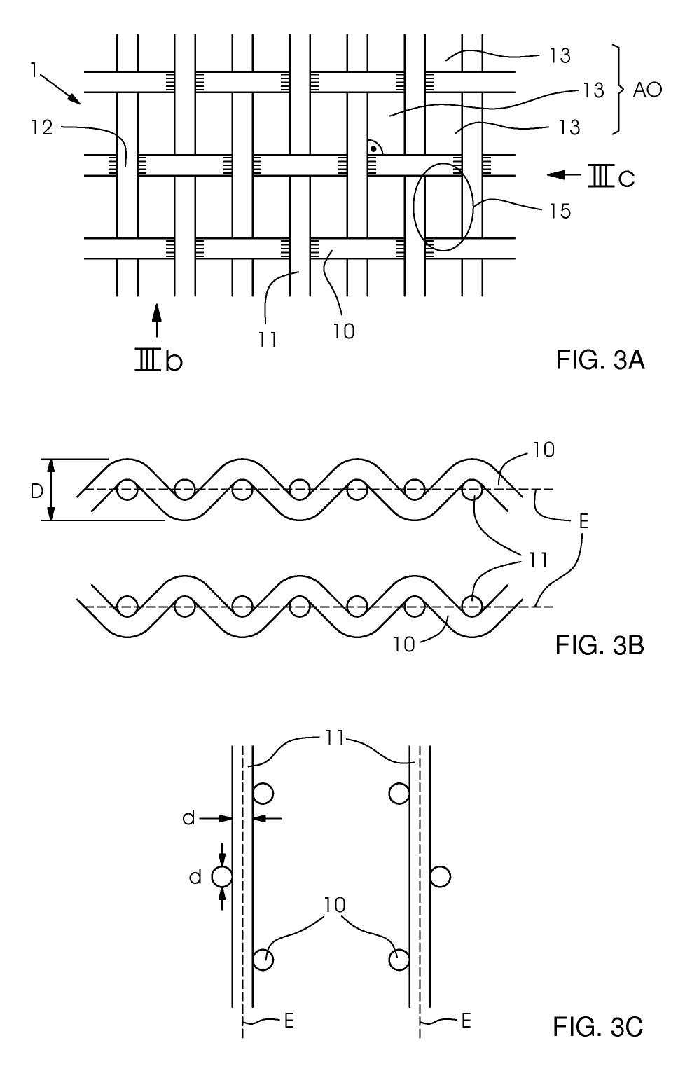

FIG. 3A is a diagrammatic, elevational view of the screen material in a 1:1 plain weave;

FIG. 3B shows diagrammatic, sectional views of the screen material illustrated in FIG. 3A as viewed through the warp threads;

FIG. 3C shows diagrammatic, sectional views of the screen structure illustrated in FIG. 3A as viewed through the weft threads;

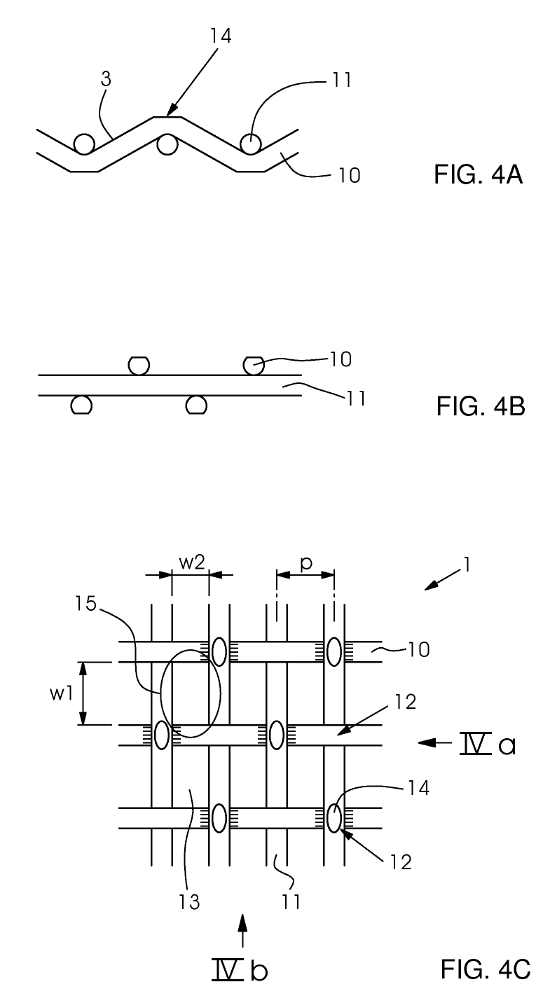

FIGS. 4A and 4B are sectional views of a screen material in a 1:1 plain weave after calendering;

FIG. 4C is an elevational view of the screen material in a 1:1 plain weave after calendering;

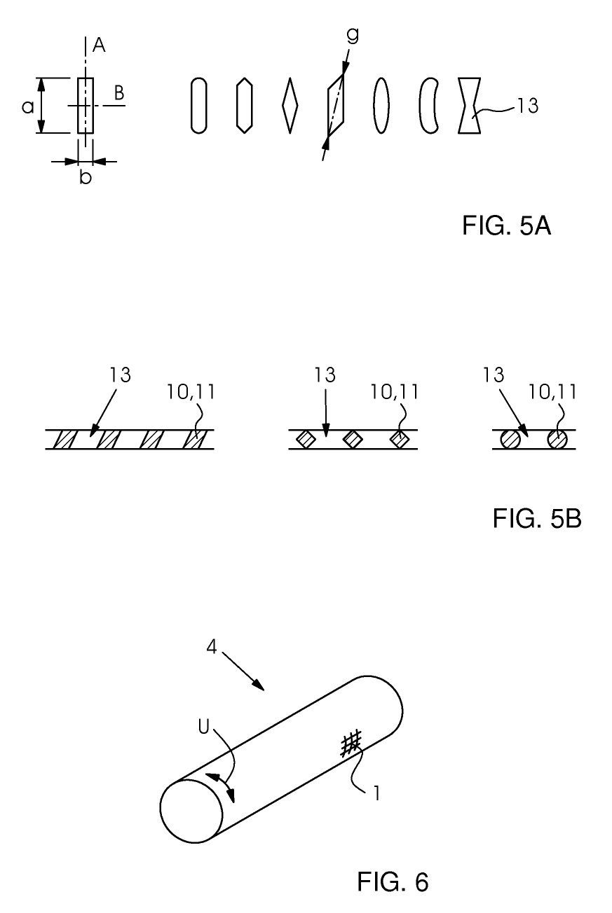

FIG. 5A is an illustration showing various possible basic shapes of the longitudinal openings of the structure in a shadow image, i.e. in an elevational view;

FIG. 5B is an illustration showing various basic shapes of the openings of the structure in a sectional view through the screen material as viewed in a direction perpendicular to the surface of the screen; and

FIG. 6 is diagrammatic, perspective view of a screen for rotary screen printing.

### DETAILED DESCRIPTION OF THE INVENTION

Referring now to the figures of the drawing in detail and first, particularly, to FIG. 1 thereof, there is shown a two-dimensional screen material 1 of the invention which is provided with a photopolymer coating 2 on one side (direct stencil). In a non-illustrated alternative embodiment, a film that has already been imaged may be applied to the screen structure 1 (indirect stencil). In this context, the nickel-plated two-dimensional screen material 1 may either be constructed as one piece, e.g. in a galvanization process, or it may be made of a fabric. Various fabric shapes are possible. FIGS. 2A-2C illustrates a 2:1 twill weave fabric; FIGS. 3A-3C illustrates a 1:1 plain weave fabric.

As shown in the elevational view of FIG. 2A, warp threads 10 and weft threads 11 form webs which create a structure 15 having longitudinal openings 13. Together, the webs 10, 11 and openings 13 may be referred to as longitudinal meshes. In FIG. 2A, the warp threads 10 and the weft threads 11 are arranged at right angles to each other. In a non-illustrated alternative embodiment, however, the warp threads 10 and the weft threads 11 may be arranged at various other angles relative to each other, thus creating diamond-shaped (or rhombus-shaped) openings 13. FIG. 2A also indicates an open screen surface A0. The open screen surface A0 calculates as the ratio between the area of the openings 13 and the total area of the screen material, which is defined as the sum of the area of the openings 13 and the area of the webs 10, 11.

FIG. 2B illustrates sectional views through the warp threads 10 of FIG. 2A. This illustration shows that in a 2:1 twill weave, a respective warp thread 10 alternately passes below one weft thread 11 and then above two weft threads 11 and so on. All weft threads 11 are located in the same plane E. This is also apparent in the sectional views of FIG. 2C taken through the weft threads 11. In a non-illustrated alternative embodiment, warp threads and weft threads extend in different planes and in particular change planes with each other. Such high-resistance screen structures are very strong and are known from screens used for filtration applications.

The screen material 1 shown in the elevational view of FIG. 3A has a 1:1 plain weave. The webs 10 and 11, which form a structure of longitudinal openings 13, are formed by warp threads 10 and weft threads 11. The structure formed by the warp threads 10 and weft threads 11 may be referred to as longitudinal meshes 15. In the illustration of FIG. 3A, the warp threads 10 and weft threads 11 are arranged at right angles to each other, thus forming rectangular longitudinal meshes 15. In a non-illustrated alternative embodiment the warp threads 10 and weft threads 11 may arranged at different angles to each other.

As shown in the sectional view of FIG. 3B taken through two warp threads 10, a respective warp thread 10 alternately passes above and below one weft thread 11. All weft threads 11 are located in the same plane E, a fact which is apparent in FIG. 3C. In a non-illustrated alternative embodiment, weft threads and warp threads may be arranged at different angles and may run in different planes and in particular may change planes with each other. Such high-resistance screen structures are very strong and are known from screens used for filtration applications.

A thickness D of the screen structure of the two-dimensional screen material 1 is indicated in FIG. 2B and in FIG. 3B. It is approximately three times a thickness d, i.e. it corresponds to the diameter of warp thread 10 and weft thread 11, respectively, multiplied by three. This ensures a high degree of stability for the two-dimensional screen material 1. The same is true for the screen material 1 shown in FIGS. 2A-2C.

FIGS. 4A to 4C illustrate a two-dimensional screen material 1 that has undergone a calendering process. In the crossings 12 where the warp threads and the weft threads 11 meet, the screen material was smoothened so as to form flat supports 14. FIG. 4C further illustrates the dimensions of the longitudinal mesh 15, with w1 indicating a mesh width in a longitudinal direction of the opening 13 and w2 indicating a mesh width in a transverse direction of the opening 13. The distance between central axes of two threads 10 and 11 is referred to as the mesh spacing p.

As an alternative to the longitudinal holes of rectangular shape shown in FIGS. 2A-2C, 3A-3C, and 4A-4C, the openings 13 may have alternative shapes. FIG. 5A gives several basic shapes as examples. A length “a” of an opening 13 in the direction of the longitudinal axis A is greater than a width “b” of the opening 13 in the direction of the transverse axis B. A greatest width of a respective opening 13 is designated by the letter g. The basic shapes shown in FIG. 5A are an oval, a rectangle, and a diamond. This list only gives examples and is not exhaustive. As shown in FIG. 5B, the openings 13 of the structure 15 of the two-dimensional screen material 1 may have different sectional profiles such as oblique profiles, for instance. This provides further optimization of the ink flow through the screen material 1.

FIG. 6 shows a screen 4 with a two-dimensional screen material 1 arranged in a cylindrical sleeve shape for rotary printing. The screen material is held in its cylindrical shape by end pieces that will not be further described herein. The interior of the screen 4 contains a doctor blade, which cannot be seen, for pressing ink through the screen material. The doctor blade may be arranged parallel to the axis of rotation of the screen 4. The circumferential direction U of the screen 4 is indicated by a double-headed arrow. The greatest width g of the openings 13 (see FIG. 5A) may be approximately oriented in the circumferential direction U. This aspect ensures a suitable flow rate of the ink, also known as good ink transfer properties. The longitudinal axes A of the openings 13 (see FIG. 5A) may be aligned so as not to be at right angles to the circumferential direction U, thus reducing what is known as the parallel-edge effect.

In a (non-illustrated) alternative embodiment, the greatest width g of the openings 13 may be arranged so as to be skewed at a 90° angle with respect to the circumferential direction U. This may be done to specifically reduce the ink flow. Aligning the greatest width g of the openings 13 relative to the circumferential direction U may thus be used as a means to manipulate the flow rate.

1. A two-dimensional screen material for use in screen printing, including rotary screen printing, the two-dimensional screen material comprising:
webs forming a screen structure and disposed at an angle relative to each other and forming said screen structure with longitudinal openings defined between said webs, said webs being made of metal at least at their surfaces, said metal being deposited on said webs in a galvanizing process, and a first width of said longitudinal openings in a direction of longitudinal axes of said longitudinal openings is greater than a second width of said longitudinal openings in a direction of transverse axes of said longitudinal openings.

2. The two-dimensional screen material according to claim 1, wherein said screen structure is thinned via a calendering process.

3. The two-dimensional screen material according to claim 1, wherein said screen structure has an open screen area of between 20% and 40%.

4. The two-dimensional screen material according to claim 1, wherein a number of said longitudinal openings per inch of said screen structure is between 20 and 400 in said direction of said longitudinal axes of said screen structure and between 50 and 600 in said direction of said transverse axes of said screen structure.

5. The two-dimensional screen material according to claim 1, wherein said screen structure is formed as one piece.

6. The two-dimensional screen material according to claim 1, wherein the two-dimensional screen material is a fabric in which said webs are made of threads and said screen structure is in a form of a longitudinal mesh.

7. The two-dimensional screen material according to claim 6, wherein said screen structure is in a form of a 1:1 plain weave.

8. The two-dimensional screen material according to claim 6, wherein said screen structure is in a form of a twill weave.

9. The two-dimensional screen material according to claim 6, wherein said threads are warp threads and weft threads, said weft threads being straight and being located in a same plane.

10. The two-dimensional screen material according to claim 9, wherein said warp threads and said weft threads have a same diameter.

11. The two-dimensional screen material according to claim 1, wherein said metal is nickel.

12. The two-dimensional screen material according to claim 8, wherein said twill weave is a 2:1 twill weave.

13. A screen for rotary printing, the screen comprising:
a two-dimensional screen material containing webs forming a screen structure and disposed at an angle relative to each other and forming said screen structure with longitudinal openings defined between said webs, said webs being made of metal at least at their surfaces, said metal being deposited on said webs in a galvanizing process, and a first width of said longitudinal openings in a direction of longitudinal axes of said longitudinal openings being greater than a second width of said longitudinal openings in a direction of transverse axes of said longitudinal openings;
said screen structure being in a shape of a cylindrical sleeve;
a greatest width of said longitudinal openings of said screen structure is approximately aligned in a direction of a circumference of the screen; and
said longitudinal axes of said screen structure are aligned at an angle selected from the group consisting of acute angles and obtuse angle relative to a circumferential direction of the screen.

14. The screen according to claim 13, wherein said two-dimensional screen material has a polymer coating on one side.

15. The screen according to claim 14, wherein said polymer coating is a photopolymer coating.
